(19) United States
(12) Patent Application Publication
(10) Pub. No.: US 2008/0060894 A1
(43) Pub. Date: Mar. 13, 2008

(54) Active vibration damper

(75) Inventors: Hironori Koyama, Kasugai-shi (JP); Atsushi Muramatsu, Komaki-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 11/892,540

(22) Filed: Aug. 23, 2007

(30) Foreign Application Priority Data
Aug. 31, 2006 (JP) 2006-236718

(51) Int. Cl. F16F 15/03; F16F 15/04

(52) U.S. Cl. 188/379

(57) ABSTRACT

An active vibration damper having: an electromagnetic oscillator with a coil member and a yoke member, one of the coil member and yoke member of the electromagnetic oscillator being fixed to a target member whose vibration to be damped while the other being elastically supported by the target member via a support rubber elastic body; and a base member having a cylindrical peripheral wall portion and a floor portion, and fixed to the target member. The support rubber elastic body is housed within the base member, and the electromagnetic oscillator is disposed outside of the base member, on an opposite side of the support rubber elastic body with the floor portion of the base member being interposed. An insertion hole is formed at the floor portion of the base member, and the other of the coil and yoke member forms a coupling rod inserted through the insertion hole and fixed to a center portion of the support rubber elastic body.

### INCORPORATED BY REFERENCE

The disclosure of Japanese Patent Application No. 2006-236718 filed on Aug. 31, 2006 including the specification, drawings and abstract is incorporated herein by reference in its entirety.

### BACKGROUND OF THE INVENTION

1. Field of the Invention

The present invention relates to an active vibration damper that is mounted on a target member whose vibration to be damped, and that is able to attenuate vibration in the target member in an active or offset fashion.

2. Description of the Related Art

To date, active vibration dampers have widely known as members to be mounted on a target member whose vibration to be damped, like a body of an automobile, for damping vibration that may cause troubles in the target member, in an active or cancellation manner. The present assignee has been proposed one type of active vibration damper of construction as disclosed in JP-A-2006-180601 (thereinafter referred to as Citation 1).

In the active vibration damper disclosed in Citation 1, an elastic rubber plate serving as a support rubber elastic body is disposed for elastically connecting a movable member and a stator to be displaceable relative to each other in a direction in which an output shaft extends. The elastic rubber plate is located on the opposite side of the target member with a coil disposed in the stator being interposed therebetween. Namely, the elastic rubber plate is located on the opposite side of the target member, which is typically made of a metallic material or the like having a heat conductivity higher than air, with the coil that will generate heat upon excitation. With this arrangement, even if an air on the target member side of the heat source, i.e., the coil, is warmed by a coil heat, the heat can be transmitted to the target member, making it possible to decrease the heat of the air. However, on the elastic rubber plate side of the coil, if the air is heated by the coil heat, it is difficult to limit the rise of the temperature of the air. As a result, the elastic rubber plate will be exposed to the air heated by the coil, whereby the elastic rubber plate is more likely to suffer from heat caused by excitation of the coil.

Furthermore, in the case where the active vibration damper shown in Citation 1 is installed on the engine compartment of an automobile, the active vibration damper is likely to be disposed with its distal end portion where the elastic rubber plate is housed being oriented toward an engine unit, due to the space allotted for the active vibration damper as well as the arrangement of the engine unit. That is, the elastic rubber plate is more likely to suffer from not only the heat generated by the coil excitation, but radiation heat of the engine, also.

As will be apparent from the aforementioned description, the active vibration damper of construction as disclosed in Citation 1 has still some room for improvement in terms of wasting of heat.

### SUMMARY OF THE INVENTION

It is therefore one object of this invention to provide an active vibration damper having a novel construction and capable of avoiding adverse effect against a support rubber elastic body from heat generated by excitation of the coil, or the like.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

According to a principle of the present invention, there is provided an active vibration damper including: an electromagnetic oscillator including a coil member and a yoke member disposed displaceable relative to each other, and generating an oscillation force between the coil member and the yoke member by means of supplying an electric current to the coil member, one of the coil member and the yoke member of the electromagnetic oscillator being adapted to be fixed to a target member whose vibration to be damped while an other of the coil member and the yoke member being elastically supported by the target member via a support rubber elastic body; and a base member having a cylindrical peripheral wall portion and a floor portion, and being adapted to be fixed to the target member. The support rubber elastic body is housed within the base member with an outside peripheral face thereof fixed to the cylindrical peripheral wall portion of the base member, and the electromagnetic oscillator is disposed outside of the base member, on an opposite side of the support rubber elastic body with the floor portion of the base member being interposed therebetween. An insertion hole is formed at the floor portion of the base member, and the other of the coil member and the yoke member of the electromagnetic oscillator forms a coupling rod inserted through the insertion hole and fixed to a center portion of the support rubber elastic body.

In the active vibration damper of construction according to the present invention, the coil is disposed on the opposite side or outside of the support rubber elastic body with the base member interposed therebetween. This makes it possible to transmit heat generated by excitation of the coil to the base member. Since the base member is connected to the target member, the heat transmitted to the base member can be transmitted to the target member.

In addition, the support rubber elastic body is disposed to be housed within the base member, making it possible to dispose the support rubber elastic body near the target member. Therefore, even if the active vibration damper is needed to be installed within the engine compartment, it is possible to dispose the support rubber elastic body away from the engine unit, irrespective of the orientation of the active vibration damper, the arrangement of the engine unit, or the like.

Accordingly, the active vibration damper of the present invention is less likely to suffer from damage of the support rubber elastic body caused by the heat as a result of excitation of the coil.

In one preferred form of the invention, the base member is a pressed metallic member wherein the cylindrical peripheral wall portion and the floor portion are integrally formed with each other. This arrangement makes it possible to readily form the base member.

In another preferred form of the invention, the damper further includes a cover member which covers an outside of the electromagnetic oscillator; and a lid member which covers an opening of the base member including the support rubber elastic body housed within, wherein areas where the electromagnetic oscillator and the support rubber elastic body are disposed are air tightly closed from an external area by the cover member and the lid member, and wherein at least one communication passage is formed so that a space formed on a floor portion side of the base member and a space formed on a lid member side positioned on opposite sides of the support rubber elastic body are held in communication with each other. This arrangement makes it possible to prevent an entry of water, dusts or other obstacles into the electromagnetic oscillator advantageously, effectively avoiding malfunction or other drawbacks of the electromagnetic oscillator.

Namely, in the electromagnetic oscillator, tiny gaps are formed between the components, especially between the coil member and the yoke member in a precise manner. Therefore, if any obstacle comes into the gap, the motion of the components is prevented by means of the obstacles. In the present invention, however, the electromagnetic oscillator is housed within the tightly closed area, thereby effectively avoiding entry of the obstacles into the oscillator. Also, a gap formed between the coil member and yoke member can be made tiny sufficiently, making it possible to enhancing output efficiency of the oscillator.

In this preferred form, furthermore, the space formed on a floor portion side of the base member and the space formed on a lid member side positioned on opposite sides of the support rubber elastic body are held in communication with each other via the communication passage. Therefore, when the air in the space on the floor portion side undergoes expansion due to heat generated by the coil excited, an air pressure difference between the space on the floor portion side and the space on the lid member side can be quickly cancelled through the communication passage. This makes it possible to effectively prevent occurrence of unexpected deformation of the support rubber elastic body partitioning the space of the floor portion side and the space on the lid member side, due to the pressure difference between the two spaces. As a result, the relative positioning between the coil member and the yoke member can be set with high precision, making it possible for the damper to exhibit desired oscillation force precisely. Thus, the present active vibration damper is able to exhibit excellent damping effect with respect to vibration caused in the target member.

By preventing unexpected elastic deformation of the support rubber elastic body, it is also prevented that the spring characteristics of the damper will be changed due to the unexpected deformation of the support rubber elastic body. Thus, the present active vibration damper is able to exhibit desired damping effect advantageously by providing desired oscillation force with precisely.

Furthermore, since the two spaces formed on the both sides of the support rubber elastic body are held in communication through the communication hole, operation of the electromagnetic oscillator is never influenced by air spring. Thus, the desired damping effect can be achieved effectively.

In the present form, additionally, the two spaces on both sides of the support rubber elastic body can be connected together with an extremely simple construction, without needing a special component, like a gas-permeable hydrophilic film, leading to a reduced manufacturing cost.

In the construction as described above, the cover member is preferably formed of a metal or other rigid materials in order to provide its sufficient durability. It may be partially or entirely formed with a soft material, alternatively, whereby a pressure increase in the air-tightly closed space can be moderated.

In yet another preferred form of the invention; an opening of the cover member is attached fitting externally onto the cylindrical peripheral wall portion of the base member, and the one of the coil member and the yoke member of the electromagnetic oscillator is fixedly supported by the cover member and the base member. This arrangement makes it possible to delete the need for an additional special component for supporting one of the coil member and the yoke member fixedly.

In still another preferred form of the invention, the damper further includes a connecting fitting fixed to the center portion of the support rubber elastic body. The coupling rod is fixed to the connecting fitting, and the connecting fitting is opposed to the floor portion of the base member with a given spacing therebetween, and wherein a cushion rubber is formed on at least one of opposed faces of the connecting fitting and the floor portion in order to provide a stopper mechanism to limit an extent of relative displacement of the coil member and the yoke member of the electromagnetic oscillator in a cushion-wise manner by means of the connecting fitting and the floor portion coming into abutment with each other via the cushion rubber. This arrangement advantageously limits an amount of relative displacement between the coil member and the yoke member. As a result, the electromagnetic oscillator is able to avoid effectively its malfunction caused by excessive relative displacement between the coil member and the yoke member.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is an elevational view in axial or vertical Cross section of an active vibration damper of construction according to a first embodiment of the invention, taken along line 1-1 of FIG. 2; and

FIG. 2 is a top plane view of the active vibration damper of FIG. 1.

### DETAILED DESCRIPTION OF PREFERRED EMBODIMENTS

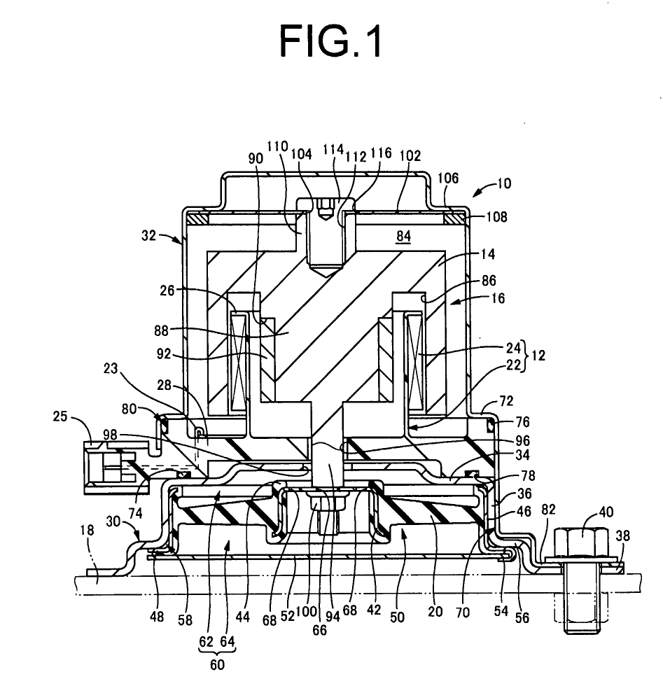

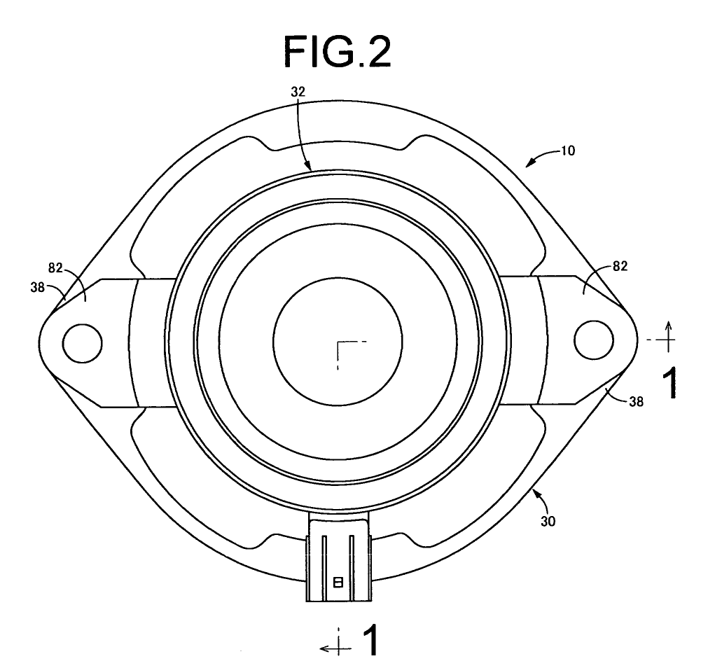

FIGS. 1 and 2 show an active vibration damper 10 of construction according to a first embodiment of the invention. The active vibration damper 10 includes an electromagnetic oscillator 16 wherein a coil member 12 and a yoke member 14 are disposed while being displaceable relative to each other. By supplying an electric current to the coil member 12, oscillation force is generated between the coil member 12 and the yoke member 14. Upon installation of the active vibration damper 10, the coil member 12 is fixed to a target member in the form of a vehicle body 18 whose vibration to be damped, while the yoke member 14 is elastically supported by the vehicle body 18 via a support rubber elastic body 20. With this state, the oscillation force generated between the coil member 12 and the yoke member 14 upon application of an electric current to the coil member 12 is applied to the vehicle body 18, so that vibration in the vehicle body 18 is able to be damped in an active or offset fashion. In the following description, a vertical direction shall mean the vertical direction in FIG. 1, which is identical to a direction of displacement of the yoke member 14.

Described in detail, the coil member 12 includes a bobbin 22 and a coil 24 wound around the bobbin 22. The bobbin 22 is made of a non-magnetic material, such as a synthetic resin material, and has a round tubular shape with a bottom overall. In this embodiment, the bobbin 22 includes a flange portion 26 integrally formed at an open end of its tubular wall so as to project diametrically outward over an entire circumference. Also, in this embodiment, a bottom wall portion 28 of the bobbin 22 has a large thickness and projects diametrically outward over an entire circumference. The coil 24 of this embodiment is wound around the tubular wall of the bobbin 22 while leaning against the flange portion 26 side. One end of the coil 24 is connected with one of a pair of terminals 23 embedded in the bottom wall portion 28 of the bobbin 22, while the other end of the coil 24 is connected with the other of the pair of the terminals 23. Each of the pair of the terminals 23 has one end connected with the coil 24, and has the other end positioned within a connector section 25 provided in an outer circumferential portion of the bottom wall portion 28. Accordingly, it is possible to supply an electric power to the coil 24 from an external power supply via the pair of the terminals 23.

The coil member 12 of this construction is adapted to be fixed to the vehicle body 18 by means of a base metal member 30 serving as a base member and adapted to be fixed to the vehicle body 18. In this embodiment in particular, the coil member 12 is sandwiched and secured between the base metal member 30 and a cover metal member 32 serving as a cover member and fixed to the base metal member 30. In this state, the coil member 12 is adapted to be fixed to the vehicle body 18 via the base metal member 30.

The base metal member 30 has an inverted cup shape or an inverted shallow bowl shape overall, and includes an upper floor portion 34 serving as a floor portion and a cylindrical peripheral wall portion 36. The base metal member 30 is formed of a sheet of metal plate by a pressing process. That is, the base metal member 30 according to this embodiment is formed of a pressed fitting or a pressed metallic member such that the cylindrical peripheral wall portion 36 and the upper floor portion 34 are integrally formed with each other. The base metal member 30 has a pair of fixing edges 38, 38 formed at an opening edge of the cylindrical peripheral wall portion 36. With the pair of fixing edges 38, 38 fixed to the vehicle body 18 by tightening up bolts 40, the base metal member 30 is adapted to be attached to the vehicle body 18.

The support rubber elastic body 20 is housed within the base metal member 30. The support rubber elastic body 20 has a ring plate shape overall, and includes an inner metal member 42 of an inverted cup shape serving as a connecting fitting with an outside peripheral face of its peripheral wall bonded by vulcanization to an inside peripheral face of the support rubber elastic body 20.

In this embodiment, a cushion rubber 44 of annular block shape is integrally formed on an upper end of an inside peripheral edge portion of the support rubber elastic body 20. The cushion rubber 44 is bonded by vulcanization to an outside peripheral edge portion of an upper wall of the inner metal member 42 so as to project axially upwardly.

The support rubber elastic body 20 includes an outer metal member 46 of thin-walled large-diameter cylindrical shape overall with its inside peripheral face bonded by vulcanization to an outside peripheral face of the support rubber elastic body 20. The outer metal member 46 bonded by vulcanization to the outside peripheral face of the support rubber elastic body 20 is placed in a coaxial relationship with the inner metal member 42.

The outer metal member 46 according to the present embodiment has an axially upper end slightly bent to a radially inner side, and has an axially lower end bent to a radially outer side to form an annular disk shaped fixing portion 48. An upper edge of the support rubber elastic body 20 according to the present embodiment extends so as to cover the axially upper end of the outer metal member 46 and is bonded by vulcanization to the axially upper side of an outer circumferential surface of the outer metal member 46, while a lower edge of the support rubber elastic body 20 extends so as to be bonded by vulcanization to the annular disk shaped fixing portion 48.

As will be apparent from the above description, the support rubber elastic body 20 according to this embodiment is formed as an integrally vulcanization molded product 50 including the inner metal member 42 and the outer metal member 46.

In this embodiment, an outer circumferential edge of a thin, disk-shaped lid plate 52 serving as a lid member is superposed against the annular disk shaped fixing portion 48 of the outer metal member 46 from the below. In this state, caulking edges 54 formed at an appropriate number of locations along the circumference of the annular disk shaped fixing portion 48 are detained by caulking against the lid plate 52, whereby the lid plate 52 covers a lower opening of the outer metal member 46.

The integrally vulcanization molded product 50 of the support rubber elastic body 20 against which the lid plate 52 is detained by caulking as described above is housed within and attached to the base metal member 30 by means of the outer metal member 46 being press fit into the cylindrical peripheral wall portion 36 of the base metal member 30. With this arrangement, the support rubber elastic body 20 has its outside peripheral edge portion supported by the cylindrical peripheral wall portion 36 of the base metal member 30 and is disposed so as to spread in an axis-perpendicular direction of the base metal member 30. The cushion rubber 44 bonded by vulcanization to the inner metal member 42 is opposed to the upper floor portion 34 of the base metal member 30 with a given spacing therebetween, thereby permitting displacement of the support rubber elastic body 20 in an axial direction. Note that the support rubber elastic body 20 disposed within the base metal member 30 is positioned in a coaxial relationship with the base metal member 30.

In the above-described state where the integrally vulcanization molded product 50 of the support rubber elastic body 20 against which the lid plate 52 is detained by caulking is attached to the base metal member 30, the upper edge of the support rubber elastic body 20 which covers the axially upper end of the outer metal member 46 is sandwiched between the upper floor portion 34 of the base metal member 30 and the axially upper end of the outer metal member 46, while the annular disk shaped fixing portion 48 is superposed against a shoulder portion 56 formed at the cylindrical peripheral wall portion 36 of the base metal member 30.

In this embodiment, the integrally vulcanization molded product 50 of the support rubber elastic body 20 against which the lid plate 52 is detained by caulking as described above is attached to the base metal member 30, whereby the lid plate 52 covers an opening 58 of the base metal member 30. With this arrangement, an area formed between opposed faces of the upper floor portion 34 of the base metal member 30 and the lid plate 52 (hereinafter referred to as “first area 60”) is divided into two spaces by the support rubber elastic body 20, namely, the upper floor portion 34 side space (hereinafter referred to as “upper space 62”) and the lid plate 52 side space (hereinafter referred to as “lower space 64”).

In this embodiment, the inner metal member 42 has a central hole 66 formed at a center portion of its upper wall and a plurality of communication holes 68 serving as communication passages formed around the central hole 66. With this arrangement, the upper and lower spaces 62, 64 are held in communication with each other through the plurality of the communication holes 68.

The cover metal member 32 attached to the base metal member 30 is formed of a metallic material and is of a deep, inverted cup shape overall having a peripheral wall and an upper wall. In this embodiment, the cover metal member 32 is formed of a sheet of metal plate by a pressing process, like the base metal member 30.

The cover metal member 32 of this construction caps the base metal member 30 from above, and is attached to the base metal member 30 by means of an opening 70 of the cover metal member 32 being fitted externally onto the cylindrical peripheral wall portion 36 of the base metal member 30 with the coil member 12 superposed against the upper floor portion 34 in a concentric arrangement.

In this embodiment, the cover metal member 32 has a medial stepped portion 72 formed at its axially medial portion. In a state with the cover metal member 32 attached to the base metal member 30 by means of the opening 70 of the cover metal member 32 being fitted externally onto the cylindrical peripheral wall portion 36 of the base metal member 30 as described above, an outside peripheral edge portion of the bottom wall portion 28 of the coil member 12 is sandwiched and fixed between an outside peripheral edge portion of the upper floor portion 34 of the base metal member 30 and the medial stepped portion 72 of the cover metal member 32.

In this embodiment, in a state with the outside peripheral edge portion of the bottom wall portion 28 of the coil member 12 sandwiched and fixed between the outside peripheral edge portion of the upper floor portion 34 of the base metal member 30 and the medial stepped portion 72 of the cover metal member 32 as described above, an annular sealing rubber 74 is gripped between the upper floor portion 34 of the base metal member 30 and the coil member 12 superposed against each other so as to provide a fluid-tight sealing therebetween, while an annular sealing rubber 76 is gripped between a peripheral wall of the cover metal member 32 and the coil member 12 superposed against each other so as to provide a fluid-tight sealing therebetween. In this embodiment, the sealing rubber 74 is housed within a groove 78 formed at the coil member 12, while the sealing rubber 76 is housed within a groove 80 formed by a stepped portion provided at the coil member 12 and the medial stepped portion 72 of the cover metal member 32.

The cover metal member 32 attached to the base metal member 30 as described above has a pair of fixing edges 82, 82 formed at its opening end. With the pair of fixing edges 82, 82 superposed against the pair of the fixing edges 38, 38, respectively, and fixed to the vehicle body 18 by tightening up the bolts 40, the cover metal member 32 is adapted to be fixed to the vehicle body 18 together with the base metal member 30.

In this embodiment, as described above, the cover metal member 32 and the base metal member 30 are fluid-tightly attached to each other while the opening 58 of the base metal member 30 is fluid-tightly covered by the lid plate 52. With this arrangement, an area formed between opposed faces of the upper floor portion 34 of the base metal member 30 and the upper wall of the cover metal member 32 (hereinafter referred to as “second area 84”) as well as the first area 60 are air tightly closed from the external area.

The second area 84 formed by means of the cover metal member 32 being attached to the base metal member 30 as described above includes the coil member 12 disposed therein. Within this second area 84, the yoke member 14 is disposed so as to be displaceable relative to the coil member 12. In other words, the coil member 12 and the yoke member 14, which constitute the electromagnetic oscillator 16, are disposed on the opposite side of the support rubber elastic body 20 with the upper floor portion 34 of the base metal member 30 being interposed therebetween.

The yoke member 14 is formed of a ferromagnetic material and has a generally thick, cylindrical block shape overall. The yoke member 14 has an annular groove 86 opening in a lower end face thereof and continuously extending with substantially unchanging cross section (in this embodiment, a rectangular cross section) about the center axis over the entire circumference, thereby forming a central protrusion 88 projecting downward from a center portion of the yoke member 14.

Here, the central protrusion 88 has a stepped face 90 formed at an axially medial portion of its outer circumferential surface, thereby providing a large-diameter portion to the upper side (basal end side) of the stepped face 90 and a small-diameter portion to the lower side (protruding end side) thereof. In this embodiment, a permanent magnet 92 of thick, cylindrical shape and magnetized with different magnetic poles to its inner and outer peripheral surface sides is secured fit around the small-diameter portion of the central protrusion 88. Accordingly, magnetic poles different from each other appear at either side of the annular groove 86 of the yoke member 14, whereby the magnetic field occurs within the annular groove 86.

The yoke member 14 of this construction is disposed within the second area 84 with the coil 24 wound around the tubular portion of the bobbin 22 of the coil member 12, positioned within the annular groove 86, and inserted between the permanent magnet 92 and the yoke member 14 opposed in the axis-perpendicular direction, whereby the coil 24 is located in the magnetic field generated by the permanent magnet 92 and the yoke member 14. Note that the coil 24 is disposed to be isolated from both the yoke member 14 and the permanent magnet 92. With the yoke member 14 disposed within the second area 84, the central protrusion 88 provided to the yoke member 14 is accommodated within the tubular wall of the bobbin 22 of the coil member 12.

A coupling rod 94 projecting downward is integrally formed with the central protrusion 88 of the yoke member 14. In a state with the yoke member 14 disposed within the second area 84 as described above, the coupling rod 94 is inserted through a through hole 96 formed at the bottom wall portion 28 of the bobbin 22, an insertion hole 98 formed at the upper floor portion 34 of the base metal member 30, and the central hole 66 formed at the upper wall of the inner metal member 42. In this state, a nut 100 is screwed on the distal end of the coupling rod 94, whereby the upper wall of the inner metal member 42 is forcedly gripped or supported between a stepped surface formed at an axially medial portion of the coupling rod 94 and the nut 100. Accordingly, the coupling rod 94 is fixed to the inner metal member 42. As will be apparent from the above description, the yoke member 14 is elastically supported with respect to the vehicle body 18 via the support rubber elastic body 20 and the base metal member 30.

In addition, a leaf spring 102 is disposed above the yoke member 14. The leaf spring 102 is of thin disk shape overall having a center hole 104 penetrating its center portion. An outside peripheral edge of the leaf spring 102 is forcedly gripped or supported between a roof-side shoulder portion 106 formed near the upper wall of the cover metal member 32 and an annular-shaped abutting member 108 inserted fitting within the cover metal member 32, while an inside peripheral edge of the leaf spring 102 is forcedly gripped or supported between a protrusion 110 formed projecting from an upper face of the yoke member 14 and a bolt 114 screwed in a screw hole 112 formed at the protrusion 110. With this arrangement, the leaf spring 102 is disposed above the yoke member 14.

The leaf spring 102 has a plurality of perforations 116 spirally prolonged from its inner circumferential side toward an outer circumferential side, in order to adjust the spring characteristics in the axial direction. The perforations 116 of the leaf spring 102 allow communication between spaces on axially upper and lower sides of the leaf spring 102.

In the active vibration damper 10 of this construction, when an electric power is supplied to the coil 24 from an external power supply, an oscillation force is generated by the current flowing through the magnetic field formed by the permanent magnet 92 and the yoke member 14. By means of this generated oscillation force, the yoke member 14 is forced to move in the axial direction with respect to the coil member 12. As a result, the active vibration damper 10 is able to apply the desired oscillation force on the vehicle body 18, thereby damping vibration excited in the vehicle body 18 in an active or cancellation fashion. Note that the current energized in the coil 24 may be Alternating Current controlled according to a frequency of vibration in the target member, or may alternatively be Direct Current flowing at a certain period by means of being executed an ON/OFF control at a certain period.

In the active vibration damper 10 of the above-described construction, the support rubber elastic body 20 is positioned at a lower side of the upper floor portion 34 of the base metal member 30 (the vehicle body 18 side) while the coil member 12 is positioned at an upper side thereof (opposite side from the vehicle body 18). With this arrangement, even in the case the coil 24 generates heat by being applied an electric current therethrough, it is possible to transmit the heat to the base metal member 30. Since the base metal member 30 is fixed to the vehicle body 18, the heat transmitted to the base metal member 30 is able to be further transmitted to the vehicle body 18.

In addition, since the support rubber elastic body 20 is positioned so as to be housed within the base metal member 30, even in the case where the active vibration damper 10 is disposed within an engine compartment, it is possible to position the support rubber elastic body 20 spaced apart from an engine unit regardless of mode of placement of the active vibration damper 10 or construction of the engine unit.

Accordingly, the active vibration damper 10 of above-described construction allows the support rubber elastic body 20 to be less likely to be subjected to heat due to supplying an electric current to the coil 24, or the like.

In the active vibration damper 10 according to this embodiment, both of the first area 60 where the support rubber elastic body 20 is disposed and the second area 84 where the electromagnetic oscillator 16 is disposed are air tightly closed from the external area. Therefore, entry of debris into the vibration damper 10 is advantageously prevented, thereby enhancing operation stability of the electromagnetic oscillator 16.

Additionally, in the active vibration damper 10 according to this embodiment, the upper and lower spaces 62, 64 are held in communication with each other through the plurality of communication holes 68. Therefore, unexpected deformation of the support rubber elastic body 20 due to expansion of the air warmed by generation of heat by the coil 24 is advantageously prevented, thereby advantageously preventing malfunction of the electromagnetic oscillator 16.

Furthermore, in the active vibration damper 10 according to this embodiment, the cover metal member 32 is attached to the base metal member 30 so that the coil member 12 is sandwiched and secured between the base metal member 30 and the cover metal member 32. Therefore, the coil member 12 can be secured without needing any additional components for this purpose. As a result, an efficient assembly operation of the active vibration damper 10 can be realized.

Still further, in the active vibration damper 10 according to this embodiment, the upper wall of the inner metal member 42 will come into abutment with the upper floor portion 34 of the base metal member 30 via the cushion rubber 44, thereby limiting in a cushion-wise manner the extent of displacement of the yoke member 14 relative to the coil member 12. Therefore, it is possible to advantageously prevent excess displacement of the yoke member 14 relative to the coil member 12. As will be apparent from the above description, the upper wall of the inner metal member 42, the cushion rubber 44, and the upper floor portion 34 of the base metal member 30 together constitute a stopper mechanism.

In the active vibration damper 10 according to this embodiment, the cushion rubber 44 is integrally formed with the support rubber elastic body 20, thereby being readily manufactured.

In addition, in the active vibration damper 10 according to this embodiment, the base metal member 30 is a metallic pressed fitting such that the cylindrical peripheral wall portion 36 and the upper floor portion 34 are integrally formed with each other. This facilitates the manufacture of the base metal member 30.

While the present invention has been described in detail in its presently preferred embodiment, for illustrative purpose only, it is to be understood that the invention is by no means limited to the details of the illustrated embodiment, but may be otherwise embodied.

For example, a target member whose vibration to be damped is not limited to the vehicle body 18 shown with this embodiment.

The coupling rod 94 may be integrally formed with the connecting fitting, namely, the inner metal member 42.

It is also to be understood that the present invention may be embodied with various other changes, modifications and improvements, which may occur to those skilled in the art, without departing from the spirit and scope of the invention defined in the following claims.

What is claimed is:

1. An active vibration damper comprising:
an electromagnetic oscillator including a coil member and a yoke member disposed displaceable relative to each other, and generating an oscillation force between the coil member and the yoke member by means of supplying an electric current to the coil member, one of the coil member and the yoke member of the electromagnetic oscillator being adapted to be fixed to a target member whose vibration to be damped while an other of the coil member and the yoke member being elastically supported by the target member via a support rubber elastic body; and
a base member having a cylindrical peripheral wall portion and a floor portion, and being adapted to be fixed to the target member,
wherein the support rubber elastic body is housed within the base member with an outside peripheral face thereof fixed to the cylindrical peripheral wall portion of the base member, and the electromagnetic oscillator is disposed outside of the base member, on an opposite side of the support rubber elastic body with the floor portion of the base member being interposed therebetween; and
wherein an insertion hole is formed at the floor portion of the base member, and the other of the coil member and the yoke member of the electromagnetic oscillator forms a coupling rod inserted through the insertion hole and fixed to a center portion of the support rubber elastic body.

2. The active vibration damper according to claim 1, wherein the base member is a pressed metallic member wherein the cylindrical peripheral wall portion and the floor portion are integrally formed with each other.

3. The active vibration damper according to claim 1, further comprising: a cover member which covers an outside of the electromagnetic oscillator; and a lid member which covers an opening of the base member including the support rubber elastic body housed within, wherein areas where the electromagnetic oscillator and the support rubber elastic body are disposed are air tightly closed from an external area by the cover member and the lid member, and wherein at least one communication passage is formed so that a space formed on a floor portion side of the base member and a space formed on a lid member side positioned on opposite sides of the support rubber elastic body are held in communication with each other.

4. The active vibration damper according to claim 3, wherein an opening of the cover member is attached fitting externally onto the cylindrical peripheral wall portion of the base member, and the one of the coil member and the yoke member of the electromagnetic oscillator is fixedly supported by the cover member and the base member.

5. The active vibration damper according to claim 4, wherein a heat generated by exciting the coil member is transmitted to the cover member surrounding the electromagnetic oscillator and then to the target member via the base member.

6. The active vibration damper according to claim 1, further comprising a connecting fitting fixed to the center portion of the support rubber elastic body, wherein the coupling rod is fixed to the connecting fitting, and the connecting fitting is opposed to the floor portion of the base member with a given spacing therebetween, and wherein a cushion rubber is formed on at least one of opposed faces of the connecting fitting and the floor portion in order to provide a stopper mechanism to limit an extent of relative displacement of the coil member and the yoke member of the electromagnetic oscillator in a cushion-wise manner by means of the connecting fitting and the floor portion coming into abutment with each other via the cushion rubber.
